(19) United States
(12) Patent Application Publication
(10) Pub. No.: US 2011/0041091 A1
(43) Pub. Date: Feb. 17, 2011

(54) DEVICE MANAGING APPARATUS, DEVICE MANAGING METHOD, AND ICON DISPLAY CONTROL METHOD

(75) Inventors: Maki Sato, Kanagawa-ken (JP); Tsunehiro Motegi, Tokyo (JP); Mahina Nakamura, Tokyo (JP); Kazuhiro Ogura, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/852,850

(22) Filed: Aug. 9, 2010

Related U.S. Application Data
(60) Provisional application No. 61/232,864, filed on Aug. 11, 2009.
(60) Provisional application No. 61/232,951, filed on Aug. 11, 2009.

(51) Int. Cl. G06F 3/048

(52) U.S. Cl. 715/772

(57) ABSTRACT

According to an embodiment, a device managing apparatus includes: a display unit configured to display plural icons for starting setting screens respectively corresponding to plural kinds of processing functions of a target device set as a control target; a state-information acquiring unit configured to acquire state information concerning processing states of the respective plural kinds of processing functions in the target device; a waiting-time-information predicting unit configured to predict waiting time information concerning waiting times required, when the respective processing functions are instructed to perform new jobs, until start of execution of the new jobs on the basis of the state information acquired by the state-information acquiring unit; and a waiting-time reflecting unit configured to reflect the waiting time information predicted by the waiting-time-information predicting unit on display states of the icons respectively corresponding to the plural processing functions.

### CROSS-REFERENCE TO RELATED APPLICATION(S)

This application is based upon and claims the benefit of priority from: U.S. provisional application 61/232,864, filed on Aug. 11, 2009; and U.S. provisional application 61/232,951, filed on Aug. 11, 2009; the entire contents all of which are incorporated herein by reference.

### FIELD

Embodiments described herein relate generally to a technique for managing processing functions of a control target device.

### BACKGROUND

Conventionally, there is known a driver application for controlling, in a PC (Personal Computer) network-connected to an MFP (Multi Function Peripheral), the MFP through the network.

However, in the related art, when a user desires to check an operation state of the MFP, a reception state of a reservation job, or the like in the PC or the like network-connected to the MFP, the user needs to start the driver application, reach a detailed screen for state check on the driver application, and check the state.

### BRIEF DESCRIPTION OF THE DRAWINGS

FIG. 1 is a diagram of the configuration of an image processing system including a device managing apparatus according to a first embodiment;

FIG. 2 is a diagram of a block configuration in PCs 11 to 1n;

FIG. 3 is a diagram of a block configuration in an MFP 9;

FIG. 4 is a functional block diagram for explaining the device managing apparatus according to the first embodiment;

FIG. 5 is a flowchart for explaining a flow of processing (a device managing method) in the device managing apparatus according to the first embodiment;

FIG. 6 is a diagram of a state in which a device managing program in the device managing apparatus is started and only an icon 7 is screen-displayed in a display unit 806;

FIG. 7 is a diagram of a display state in a state in which a mouse is put on the icon 7 or a state in which some processing is performed (is scheduled to be performed) in the MFP 9;

FIG. 8 is a diagram for explaining details of a method of displaying icons 701 to 708;

FIG. 9 is a diagram of an example in which the icons 701 to 708 are rotated by an angle equivalent to one icon in a V1 direction from a state shown in FIG. 8;

FIG. 10 is a diagram of an execution situation of a print job received in the MFP 9 and a display example indicating how many execution-scheduled print jobs are present;

FIG. 11 is a diagram of a state in which a face photograph image of a user is displayed near the icon 7 as a balloon 7c;

FIG. 12 is a diagram of mail icons 7e1 to 7e3 and a display example of countdown;

FIG. 13 is a functional block diagram of a device managing apparatus according to a second embodiment;

FIG. 14 is a flowchart for explaining a flow of processing in the device managing apparatus according to the second embodiment;

FIG. 15 is a diagram of a state in which the user double-clicks an icon 701 with a mouse pointer mp;

FIG. 16 is a screen display example immediately after the user double-clicks the icon 701 with the mouse pointer mp;

FIG. 17 is a diagram of a positional relation between the position of the icon 701 that reaches a title area T and a window 701w to be started; and

FIG. 18 is a display example of the window 701w started by a setting screen start unit 203 on the basis of the double-click of the icon 701.

### DETAILED DESCRIPTION

Embodiments are explained below with reference to the accompanying drawings.

In general, according to an embodiment, a device managing apparatus includes an icon display unit, a state-information acquiring unit, a waiting-time-information predicting unit, and a waiting-time reflecting unit.

The icon display unit causes a display unit to display, as a list, plural icons for starting setting screens respectively corresponding to plural kinds of processing functions of a target device set as a control target.

The state-information acquiring unit acquires state information concerning processing states of the respective plural kinds of processing functions in the target device.

The waiting-time-information predicting unit predicts waiting time information concerning waiting times required, when the respective processing functions are instructed to perform new jobs, until the start of execution of the new jobs on the basis of the state information acquired by the state-information acquiring unit.

The waiting-time reflecting unit reflects the waiting time information predicted by the waiting-time-information predicting unit on display states of the icons respectively corresponding to the plural processing functions.

### First Embodiment

First, a first embodiment of the present invention is explained.

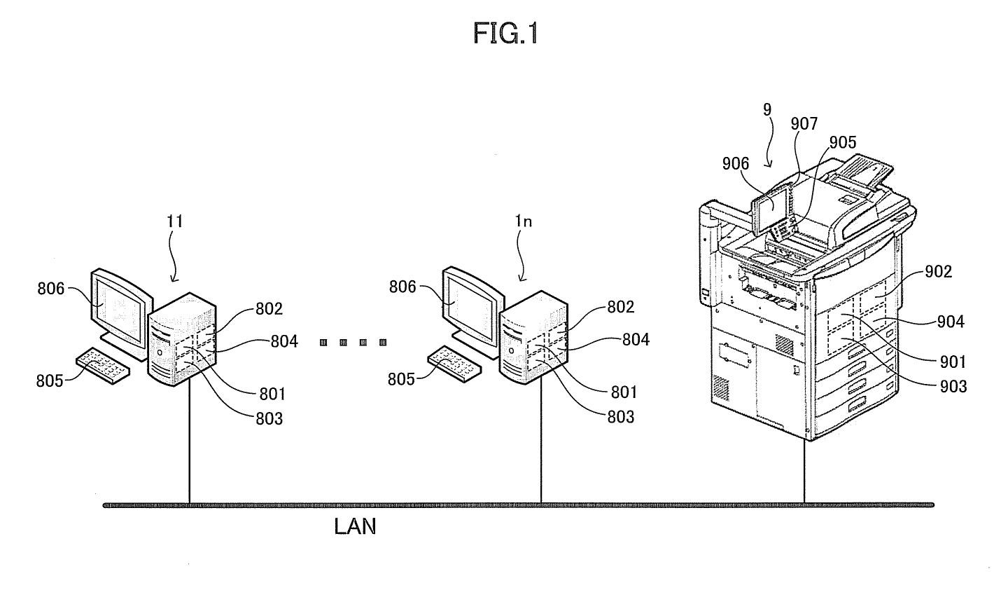

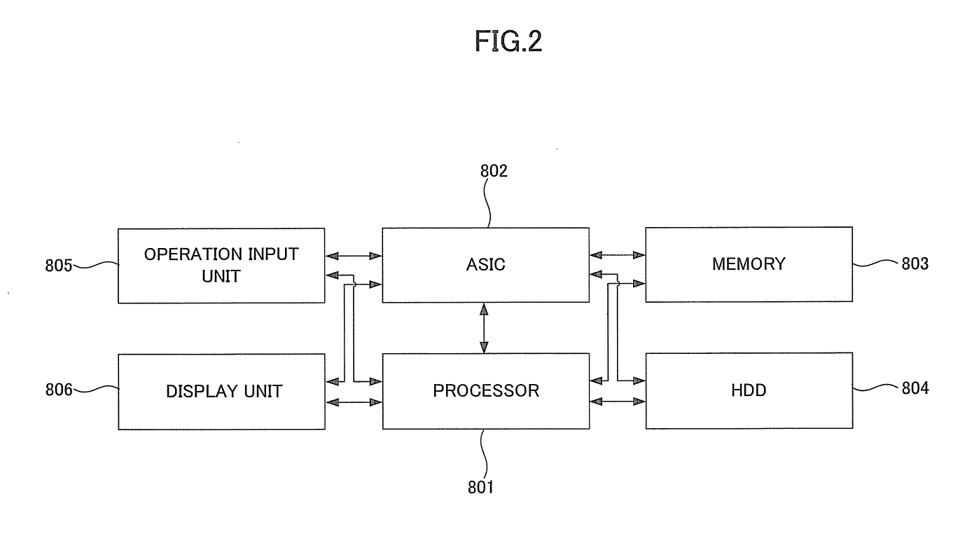

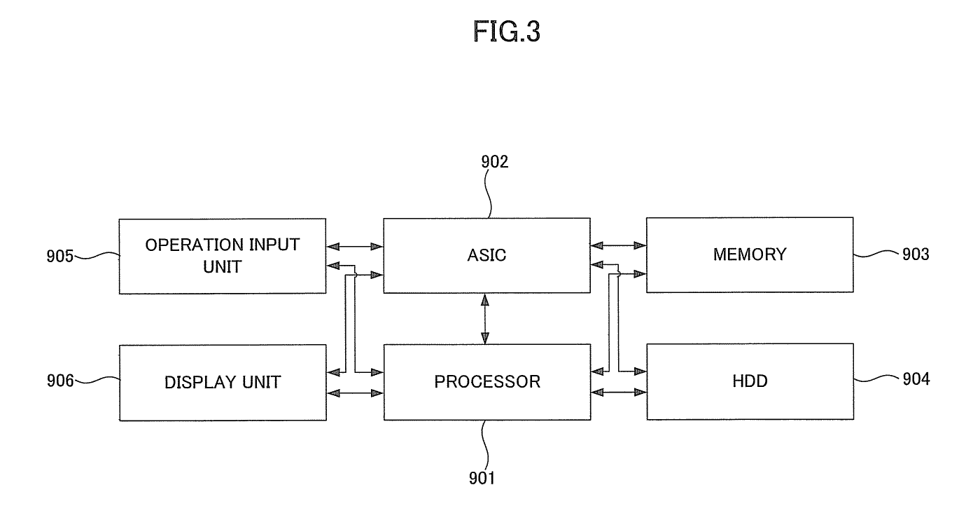

FIG. 1 is a diagram of the configuration of an image processing system including a device managing apparatus according to the first embodiment. FIG. 2 is a diagram of a block configuration in PCs 11 to 1n. FIG. 3 is a diagram of a block configuration in an MFP 9.

The image processing system according to the first embodiment includes, for example, n PCs 11 to 1n (n is an integer equal to or larger than 2) as device managing apparatuses and the MFP 9 as a management target device.

The PCs 11 to 1n and the MFP 9 are connected to be capable of communicating with each other via a network line such as a LAN (Local Area Network) or a WAN (Wide Area Network).

Each of the PCs 11 to in includes, for example, a processor 801, an ASIC (Application Specific Integrated Circuit) 802, a memory 803, an HDD (Hard Disk Drive) 804, an operation input unit 805, and a display unit 806. In each of the PCs 11 to in, a driver application (a device managing program, etc.) for realizing a print instruction, a scan instruction and a facsimile transmission instruction to the MFP 9, grasp of an operation state of the MFP 9, and the like through a network is installed.

The MFP 9 includes, for example, a processor 901, an ASIC (Application Specific Integrated Circuit) 902, a memory 903, an HDD (Hard Disk Drive) 904, an operation input unit 905, a display unit 906, and a CCD camera 907.

The CCD camera 907 automatically picks up an image of a user present near the MFP 9 on the basis of, for example, authentication processing (login processing) for the user or operation on the operation input unit 905.

The MFP 9 can execute, as plural kinds of processing functions, according to instructions from the PCs 11 to 1n, document bind processing (bind) for arbitrarily additionally editing, in document units or page units, documents stored in a storage area such as the HDD 904 of the MFP 9, group message display processing (message) for exchanging information on a real time basis when work for creating one document is divided in a group set in advance, remote facsimile transmission processing (facsimile) for remotely performing operation setting for facsimile or the like, remote copy processing (copy) for remotely performing operation setting for copying or the like, remote scan processing (scan) for remotely performing operation setting for scan or the like, history display processing (history) for displaying a processing history (log information) of print processing executed in the MFP 9, network view display processing (network) for displaying a tree view of a network, and box view processing (box) for displaying, as a view, data (image data, etc.) stored in a “box (a predetermined storage area realized by the HDD 904 or the like)” in the MFP 9.

The operation input unit 805 and the operation input unit 905 included in the apparatuses can include, for example, a keyboard, a mouse, a touch panel, a touch pad, a graphics tablet, or a dedicated button.

The display unit 806 and the display unit 906 can include, for example, an electronic paper, an LCD (Liquid Crystal Display), an EL (Electronic Luminescence), a PDP (Plasma Display Panel), or a CRT (Cathode Ray Tube).

The functions of the display units and the operation input units can also be realized by a so-called touch panel display.

In this embodiment, the processor 801 and the processor 901 have a role of performing various kinds of processing in the image processing system. The processor 801 and the processor 901 also have a role of realizing various functions by executing computer programs stored in the memory 803, the memory 903, the HDD 804, the HDD 904, and the like. It goes without saying that the processor 801 and the processor 901 can also be realized by a CPU (Central Processing Unit) or an MPU (Micro Processing Unit) that can execute equivalent arithmetic processing. Similarly, the HDD 804 and the HDD 904 can be substituted by a storage device such as a flash memory.

The memory 803 and the memory 903 can include, for example, a RAM (Random Access Memory), a ROM (Read Only Memory), a DRAM (Dynamic Random Access Memory), an SRAM (Static Random Access Memory), a VRAM (Video RAN), or a flash memory. The memory 803 and the memory 903 have a role of storing various kinds of information and computer programs used in the image processing system.

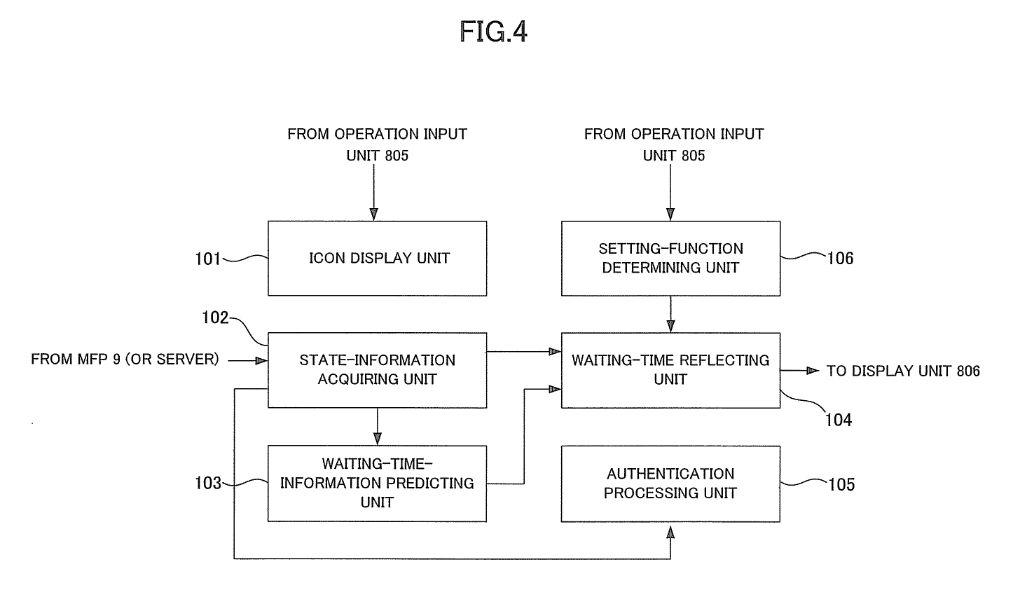

FIG. 4 is a functional block diagram for explaining the device managing apparatus according to the first embodiment.

The device managing apparatus according to the first embodiment includes, for example, an icon display unit 101, a state-information acquiring unit 102, a waiting-time-information predicting unit 103, a waiting-time reflecting unit 104, an authentication processing unit 105, and a setting-function determining unit 106.

The icon display unit 101 annularly arrays, around an icon 7 corresponding to the MFP 9, plural icons 701 to 708 for starting setting screens respectively corresponding to plural kinds of processing functions of the MFP 9 set as a control target (a target device) and causes the display unit 806 to display the icons 701 to 708 as a list. The icon display unit 101 starts, for example, a computer program for executing a desktop accessory for controlling the MFP 9 to thereby cause the display unit 806 to display a group of the icons.

Setting screens started from the icons 701 to 708 are setting screens for functions that can be remotely executed in the MFP 9. The icon 701 corresponds to document bind setting, the icon 702 corresponds to box view display, the icon 703 corresponds to network view display, the icon 704 corresponds to printing history display, the icon 705 corresponds to remote scan setting, the icon 706 corresponds to remote copy setting, the icon 707 corresponds to remote facsimile setting, and the icon 708 corresponds to group message display.

A desktop accessory for starting a PC application for remote-controlling or remote-monitoring the processing functions of the MFP 9 includes the icon 7 and the icons 701 to 708. An icon group as the desktop accessory has functions for displaying, as a list, operation states of all the processing functions of the MFP 9 and starting setting screens for remote-controlling the MFP 9.

The icon display unit 101 causes the display unit 806 to display the icons 701 to 708, for example, when the icon 7 is clicked or when a processing function for printing, data transmission, or the like is running in the MFP 9.

The state-information acquiring unit 102 acquires, on a real time basis, “state information” concerning processing states of the respective plural kinds of processing functions in the MFP 9 from the MFP 9. For example, the state-information acquiring unit 102 performs check of presence or absence of a new event in the MFP 9 at every ten seconds. It goes without saying that an acquisition source of the “state information” is not limited to the MFP 9. For example, it is also possible to centrally manage, in the PC 1n or the like, an operation state of an MFP connected to a LAN, setting content of a job being executed, and the like and acquire a part of the “state information” or the entire “state information” from a device other than the MFP 9 such as the PC 1n.

The state-information acquiring unit 102 acquires, as the “state information”, at least any one of (1) presence or absence of function execution, (2) setting content of a job being executed, (3) a processing amount (a type of processing, the number of sheets to be processed, a processed data amount, etc.) of the job being executed, (4) setting content of a job scheduled to be executed, and (5) presence or absence of setting operation in the respective plural kinds of processing functions.

The waiting-time-information predicting unit 103 predicts waiting time information concerning “waiting times required, when the respective processing functions are instructed to perform new jobs, until the start of execution of the new jobs” on the basis of the “state information” acquired by the state-information acquiring unit 102.

For example, a data table is formed in which processing amounts and setting contents of the respective processing functions and predicted waiting times are associated with each other. The prediction of waiting times can be calculated by using the data table. The data table can be stored in, for example, the HDD 804.

Examples of the “waiting time information” include the remaining number of sheets to be printed, remaining printing time [second], and the remaining number of kinds of processing [the number of jobs].

The waiting-time reflecting unit 104 reflects the “waiting time information” predicted by the waiting-time-information predicting unit 103 on display states of the icons respectively corresponding to the plural processing functions.

The waiting-time reflecting unit 104 causes the display unit 806 to perform screen display such that an icon corresponding to a processing function having longer waiting time indicated by the waiting time information predicted by the waiting-time-information predicting unit 103 is more highlighted than the other icons.

The waiting-time reflecting unit 104 causes the display unit 806 to execute, for the icon corresponding to the processing function having the longer waiting time indicated by the “waiting time information”, at least any one of (1) a reduction in a time interval of blinking, (2) an increase in the size (e.g., the height) of the icon, (3) an increase in chroma, (4) an increase in brightness, (5) an increase in line thickness, and (6) an increase in the size of a font.

The authentication processing unit 105 performs authentication processing (so-called face recognition processing) for a user on the basis of image data acquired by the state-information acquiring unit 102.

The setting-function determining unit 106 determines, on the basis of content of operation input to the operation input unit 805, for which of the plural kinds of processing functions the user is executing setting operation.

The state-information acquiring unit 102 acquires image data obtained by picking up an image of the user with the CCD camera 907 (an imaging unit). The waiting-time reflecting unit 104 causes the display unit 806 to screen-display a camera image based on the image data acquired by the state-information acquiring unit 102.

The waiting-time reflecting unit 104 can also perform reflection on a display state of the “waiting time information” concerning only an icon corresponding to a processing function that affects waiting time until execution of a processing function for which setting operation is determined by the setting-function determining unit 106 as being executed.

Processing functions and other functions that affect waiting times until execution of the processing functions are stored in, for example, the HDD 804 as a data table.

Consequently, only a congestion situation or the like of a processing function that affects execution of a processing function for which setting work is currently performed (e.g., a processing function highly likely to be continuously set) is displayed as a state. It is possible to perform grasp of a situation efficient for the user.

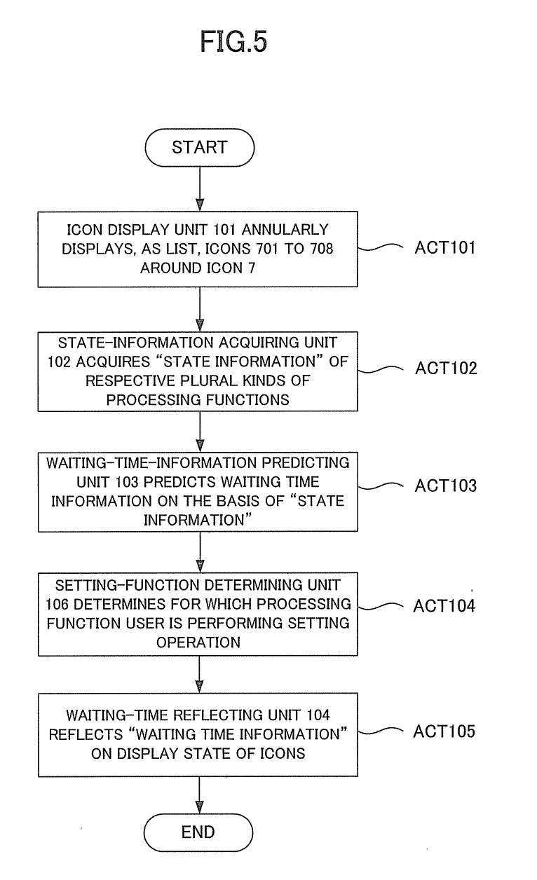

FIG. 5 is a flowchart for explaining a flow of processing (a device managing method) in the device managing apparatus according to the first embodiment.

The icon display unit 101 annularly arrays, around the icon 7 corresponding to the MFP 9, the plural icons 701 to 708 for starting setting screens respectively corresponding to the plural kinds of processing functions of the MFP 9 set as a control target (a target device) and causes the display unit 806 to display the icons 701 to 708 as a list (Act 101).

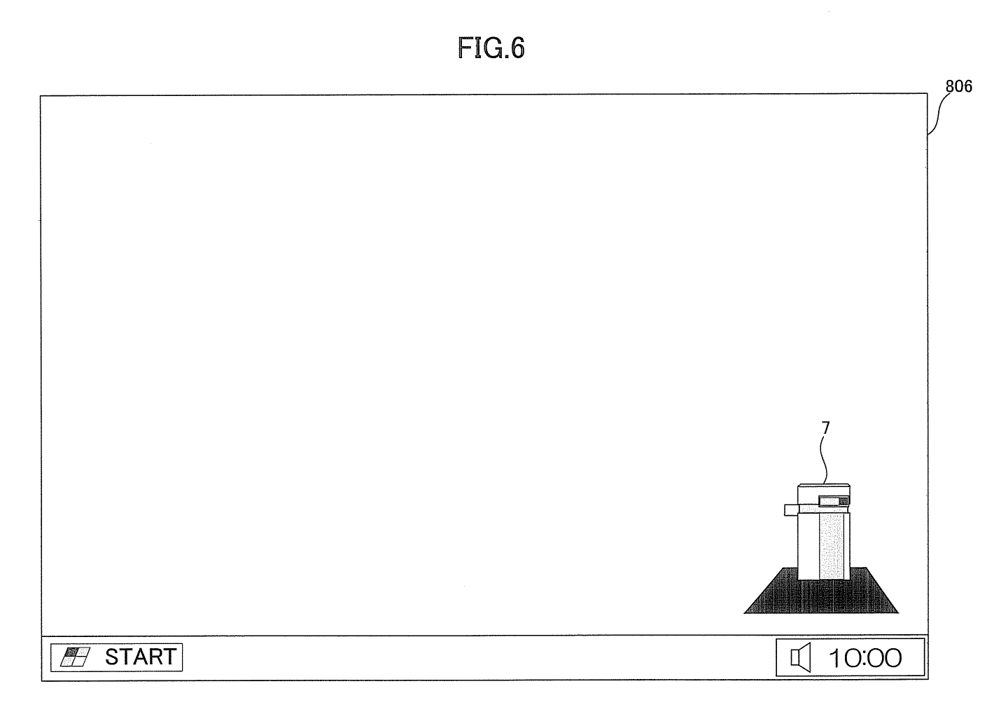

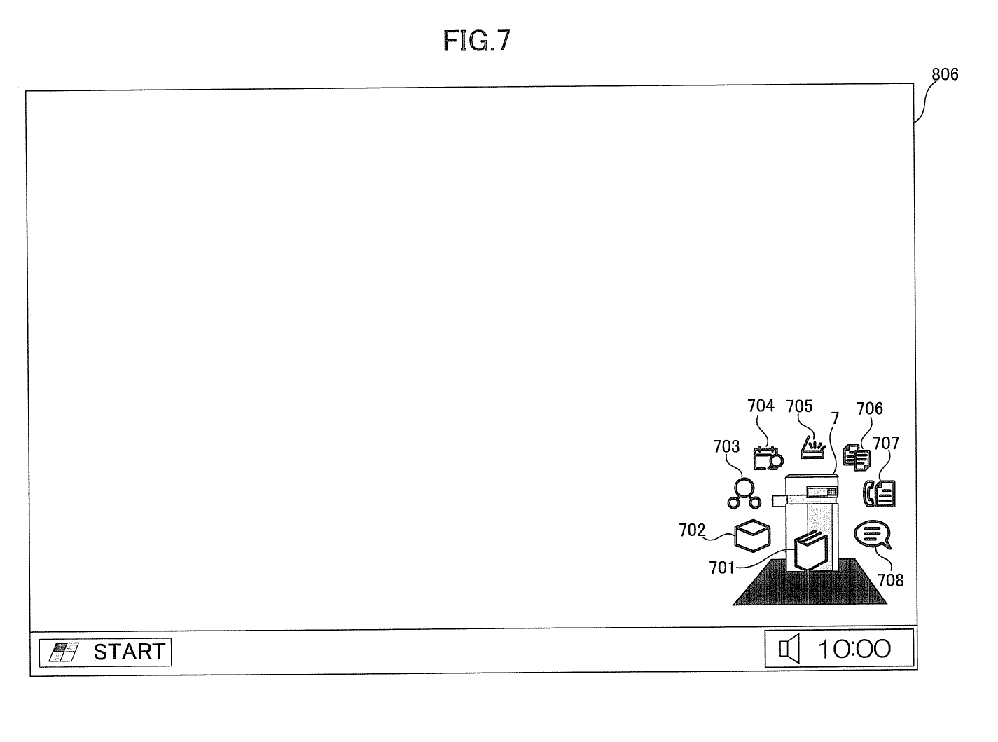

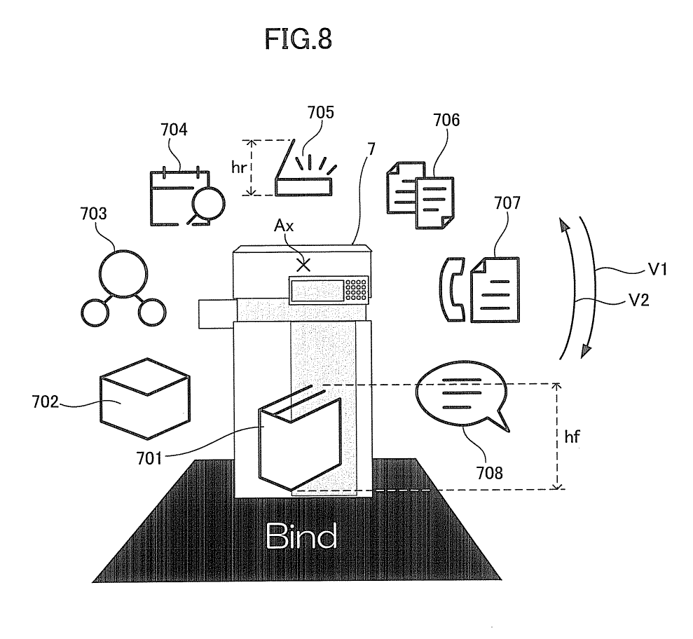

FIG. 6 is a diagram of a state in which the device managing program in the device managing apparatus is started and only the icon 7 is screen-displayed on the display unit 806. FIG. 7 is a diagram of a display state in a state in which the mouse is placed on the icon 7 or a state in which some processing is performed (is scheduled to be performed) in the MFP 9. FIG. 8 is a diagram of details of a method of displaying the icons 701 to 708.

As it is seen from FIG. 7, the icons 701 to 708 are annularly arrayed to surround around the icon 7 indicating an MFP main body. The icon display unit 101 performs, making use of the perspective, icon display such that, among the annularly-arrayed icon group, an icon located on the front side is large (height hf) and an icon located on the inner side is small (height hr<height hf).

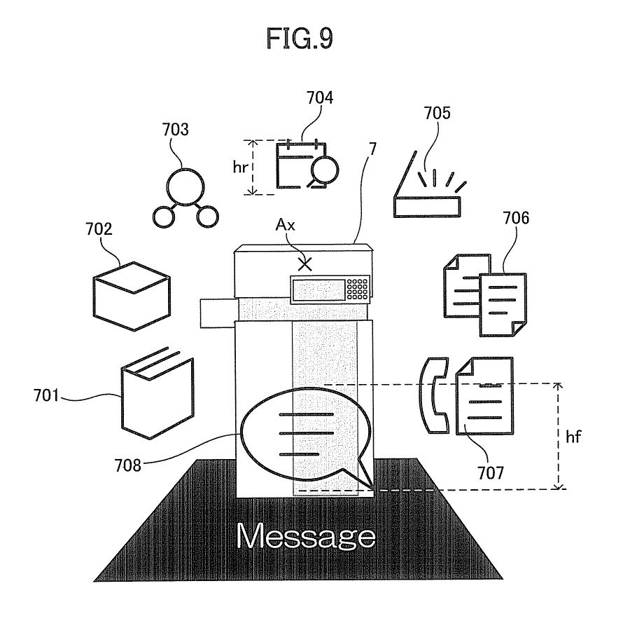

The annularly-displayed icons 701 to 708 can be rotated in a V1 direction or a V2 direction by operation in a state in which the icons are dragged by the mouse, rotating operation of a mouse wheel, or the like. FIG. 9 is a diagram of an example in which the icons 701 to 708 are rotated by an angle equivalent to one icon in the V1 direction from a state shown in FIG. 8. It is assumed that an icon located on the most front side is a currently-selected icon.

The state-information acquiring unit 102 acquires “state information” concerning processing states of the plural kinds of processing functions in the MFP 9 (ACT 102).

The waiting-time-information predicting unit 103 predicts waiting time information concerning “waiting times required, when the respective processing functions are instructed to perform new jobs, until the start of execution of the new jobs” on the basis of the “state information” acquired by the state-information acquiring unit 102 (ACT 103).

The setting-function determining unit 106 determines for which of the plural kinds of processing functions the user is executing setting operation (ACT 104).

The waiting-time reflecting unit 104 reflects the “waiting time information” predicted by the waiting-time-information predicting unit 103 on display states of the icons corresponding to the respective plural processing functions (ACT 105).

The waiting-time reflecting unit 104 performs, in association with the icon 7 and the icons 701 to 708, display of, for example, an operation state (printing, transmitting, scanning, receiving, etc.) of the MFP 9, a setting state (display of a reservation state or a setting state) of the MFP 9, an ID or a camera image of a user logging in to the MFP 9 currently set as a control target, a countdown state of the remaining number of sheets to be printed, and group work message incoming notification.

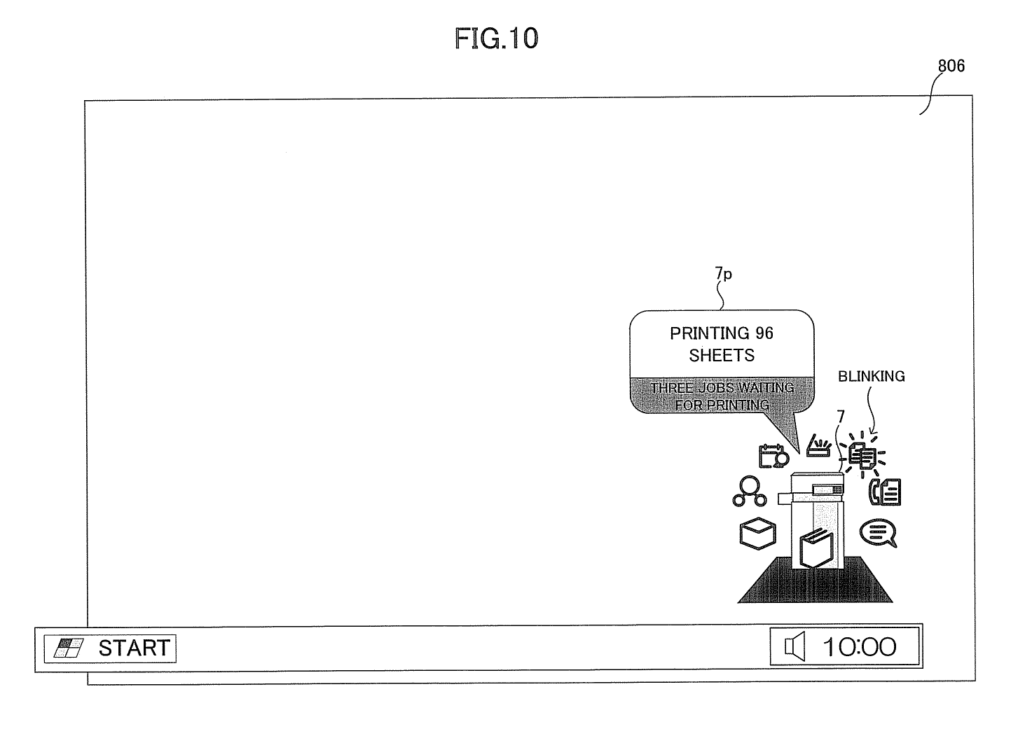

FIG. 10 is a diagram of a state in which the waiting-time reflecting unit 104 displays an execution situation of a print job received by the MFP 9 (96 sheets are being printed) and how many print jobs are to be executed (three). In an example shown in FIG. 10, only the icon 706 corresponding to the copy processing is blinking (highlighted) and the other icons are not blinking. Consequently, the user can easily grasp current and future processing congestion situations of the MFP 9 and set a result of the grasp as a determination reference for determining whether the user issues a print instruction or the like to the MFP 9.

The waiting-time reflecting unit 104 can perform reflection of the “waiting time information” on a display state concerning only an icon corresponding to a processing function that affects waiting time until execution of a processing function for which setting operation is determined by the setting-function determining unit 106 as being executed.

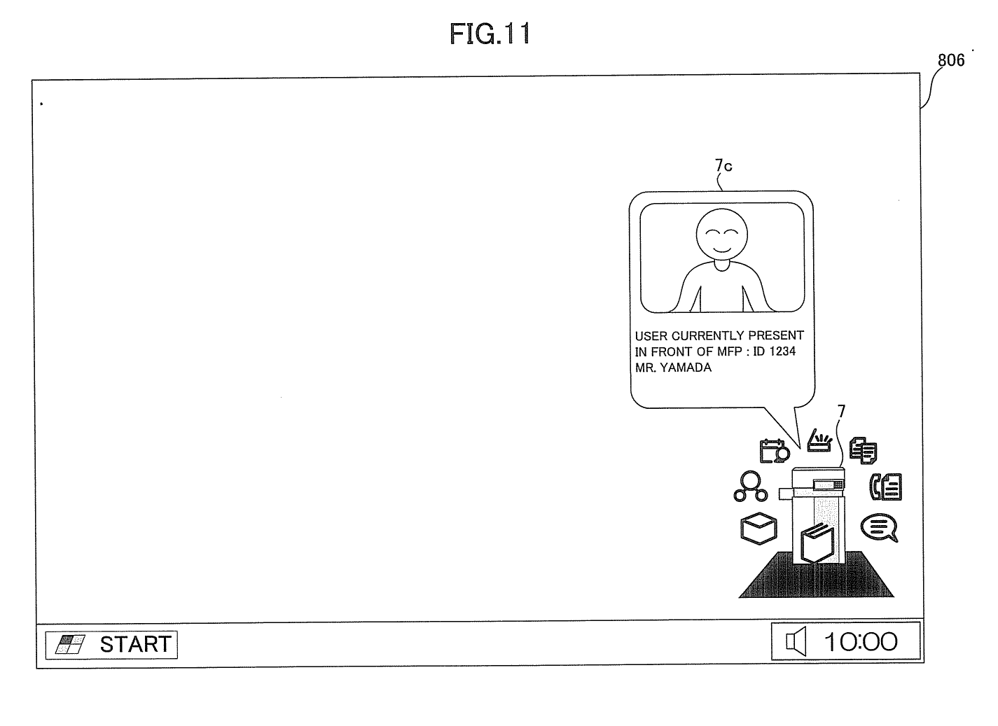

FIG. 11 is a diagram of a state in which a face photograph image of a user automatically picked up by the CCD camera 907 included in the MFP 9 is displayed near the icon 7 as a balloon 7c. Since the user of the MFP 9 can grasp what kind of user is present near a control target device in this way, in some case, it is possible to predict, for example, to which degree the MFP 9 is likely to be occupied. When it is known that the user is attempting to urgently perform work, the user of the MFP 9 can delay timing for issuing a print instruction. Since the user of the MFP 9 can grasp who is instructing or scheduled to instruct the MFP 9 to perform processing other than the user in this way, the user can grasp a situation of use of the MFP 9 conforming to an actual situation including prediction based on an average use time or the like of other users.

There is also an effect that, by displaying a face image, an ID, a name, and the like together, it is possible to check presence or absence of illegal use of login or the like due to “masquerade” in the MFP 9 through the network.

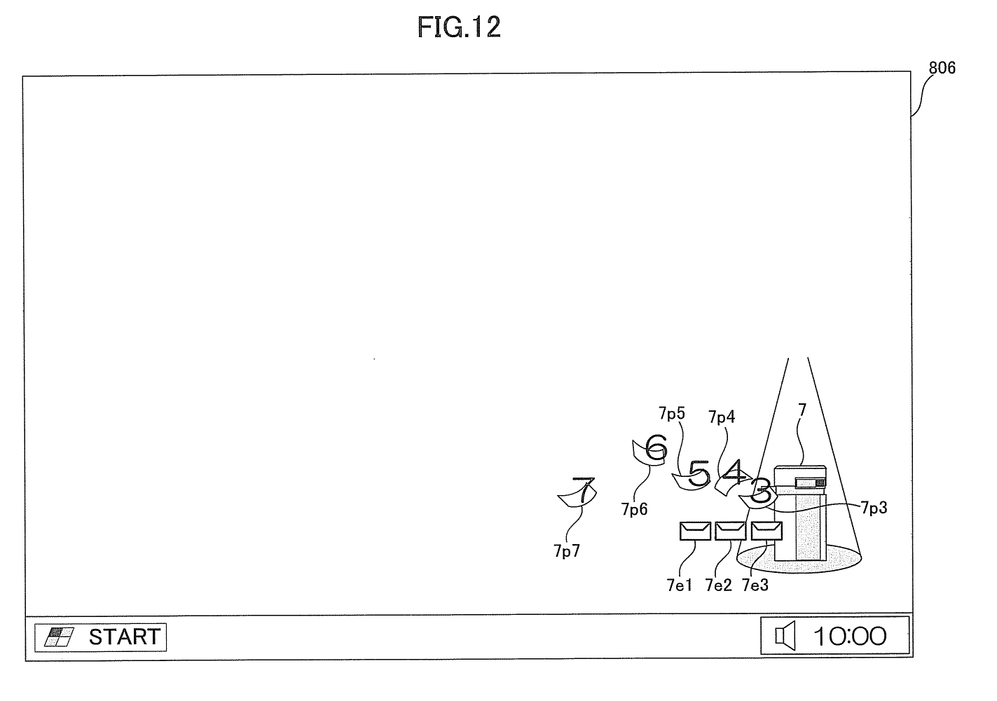

FIG. 12 is an example of mail icons 7e1 to 7e3 indicating how many received messages are present and a countdown display indicating how many sheets are to be printed to complete print processing currently performed in the MFP 9. The mail icons 7e1 and 7e3 and the countdown display are displayed near the icon 7.

The operations in the processing in the device managing apparatus explained above are realized by causing the processor 801 to execute the device managing program stored in the memory 802.

The functions of the device managing apparatus are not always limited to the realization by the PC. Instead, the functions may be realized by a server connected to the network or other MFPs. The icons 701 to 708 are not limited to the annularly-arrayed configuration. For example, the icons 701 to 708 may be arrayed along a contour of a polygon such as a rectangle or a triangle or along a straight line or a curved line.

If the icons 701 to 708 are linearly arrayed, the icons may move in a direction orthogonal to a direction of the linear array when the icons are selected. If the icons 701 to 708 are linearly arrayed, an icon closer to the center may be displayed in larger size.

In this way, according to the first embodiment, it is possible to grasp, according to display states of the functional icons 701 to 708, operation states of all processing functions of a control target device on a real time basis without starting detailed screens of a printer driver or the like.

It is possible to start, simply by performing selection of the icons 701 to 708 always displayed as a list without executing another application, the setting screens for performing setting for the respective processing functions of the MFP 9 set as a control target. This can contribute to a reduction in burdens of operability.

### Second Embodiment

A second embodiment is explained below.

The second embodiment is a modification of the first embodiment. Components having functions same as those of the components explained in the first embodiment are denoted by the same reference numerals and signs and explanation of the components is omitted.

In the past, in general, when an application is started in a PC, for example, after a user clicks an icon on a desktop, a startup screen is displayed and a desired application is started.

There is also known a configuration in which, when the user clicks an icon arranged on the desktop, after the icon bounds several times, the startup screen is displayed and an application screen is started.

However, the icon for starting the application and the started application screen are separate elements. Therefore, the icon and the application screen can be associated only by using the same design or name for the icon and the application screen.

When it takes time until the application screen is started after the user clicks the icon, no information associating the icon and the application screen is displayed in this waiting time. In some case, thinking of the user is interrupted and the user forgets what the user started.

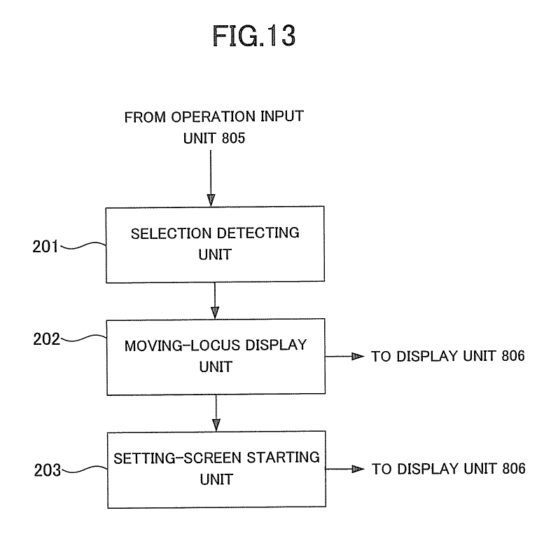

FIG. 13 is a functional block diagram of a device managing apparatus according to the second embodiment.

The device managing apparatus according to the second embodiment includes a selection detecting unit 201, a moving-locus display unit 202, and a setting-screen starting unit 203. In the same manner as the device managing apparatus according to the first embodiment, functions of the device managing apparatus according to the second embodiment can be realized by executing, with the CPU 801, the device managing program stored in the memory 803.

The selection detecting unit 201 detects selection of an icon for starting a setting screen corresponding to a processing function of the MFP 9. Specifically, the selection detecting unit 201 detects, on the basis of an operation input (e.g., double-click of the mouse) to the operation input unit 805, which icon among the icons 701 to 708 is selected.

If the selection of the icon is detected by the selection detecting unit 201, the moving-locus display unit 202 causes the display unit 806 to display, while showing a moving locus, the “selected icon”, the selection of which is detected by the selection detecting unit 201, to move from a position at the time of the selection of the selected icon to a position of a title area where a title of a setting screen of a processing function corresponding to the “selected icon” is shown.

The moving-locus display unit 202 can also change, according to a type of the “selected icon”, the selection of which is detected by the selection detecting unit 201, at least any one of (1) a time interval of blinking, (2) a shape, (3) a color, (4) brightness, (5) the thickness of a line, and (6) the size of a font of the “selected icon” compared with that before the movement.

The setting-screen starting unit 203 starts the setting screen of the processing function corresponding to the “selected icon”, the selection of which is detected by the selection detecting unit 201.

When the setting screen started by the setting-screen starting unit 203 includes plural windows, the moving-locus display unit 202 causes the display unit 806 to display, while showing a moving locus, the “selected icon” to move to a position of a title area where a title of a window set in advance as a window having highest relation (a predetermined relation) with the processing function among the plural windows corresponding to the processing function is shown.

Positions (e.g., coordinates) of title areas are set in advance according to the respective icons 701 to 708. The positions of the title areas and the icons 701 to 708 are stored in, for example, the memory 803 or the HDD 804 as a data table in which the positions and the icons are associated with each other.

The moving-locus display unit 202 causes the display unit 806 to display, while keeping a display form at the time of the selection (at an instant of the selection) of the selected icon and showing a moving locus, the “selected icon”, the selection of which is detected by the selection detecting unit 201, to move from the position at the time of the selection of the selected icon to the position of the title area where the title of the setting screen of the processing function corresponding to the selected icon is shown.

The moving-locus display unit 202 changes (e.g., shines), according to a type of the “selected icon”, selection of which is detected by the selection detecting unit 201, a display state of the “selected icon” moving from the position at the time of the selection of the “selected icon” to the position of the title area where the title of the setting screen of the processing function corresponding to the “selected icon” is shown.

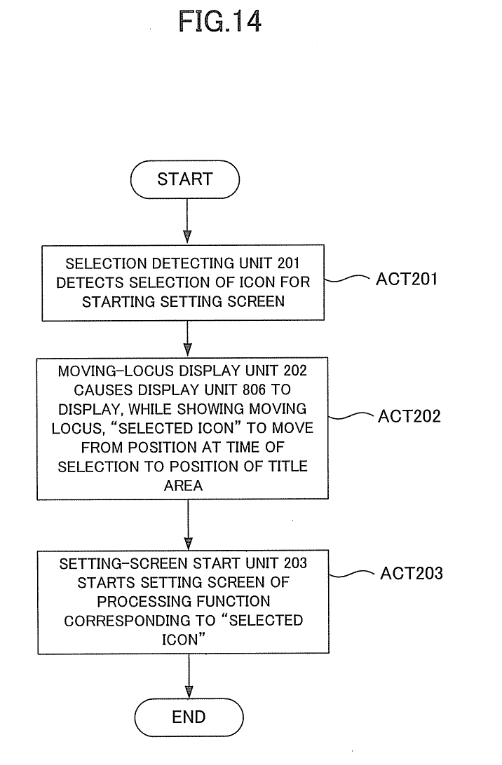

FIG. 14 is a flowchart for explaining a flow of processing (a device managing method) in the device managing apparatus according to the second embodiment.

The selection detecting unit 201 detects selection of an icon for starting a setting screen corresponding to a processing function of the MFP 9 (ACT 201).

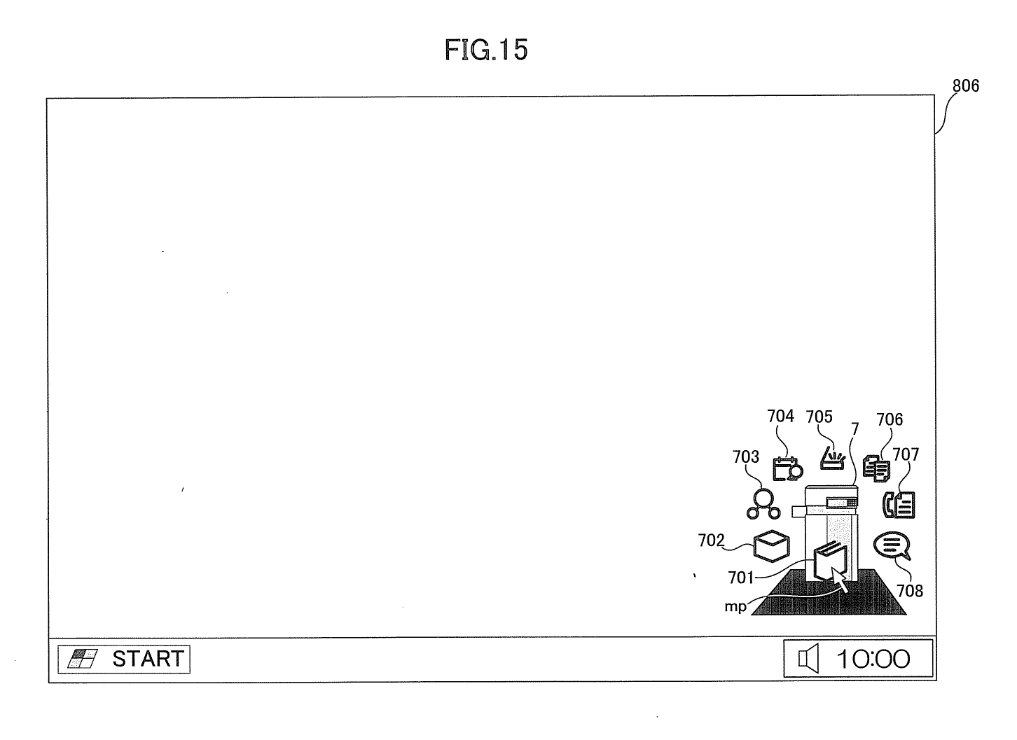

FIG. 15 is a diagram of a state in which the user double-clicks the icon 701 with the mouse pointer mp.

If selection of, for example, the icon 701 is detected by the selection detecting unit 201, the moving-locus display unit 202 causes the display unit 806 to display, while showing a moving locus L, the “selected icon” 701, the selection of which is detected by the selection detecting unit 201, to move from a position at the time of the selection of the “selected icon” 701 to a position of a title area T where a title of a setting screen of a processing function corresponding to the “selected icon” 701 is shown (ACT 202).

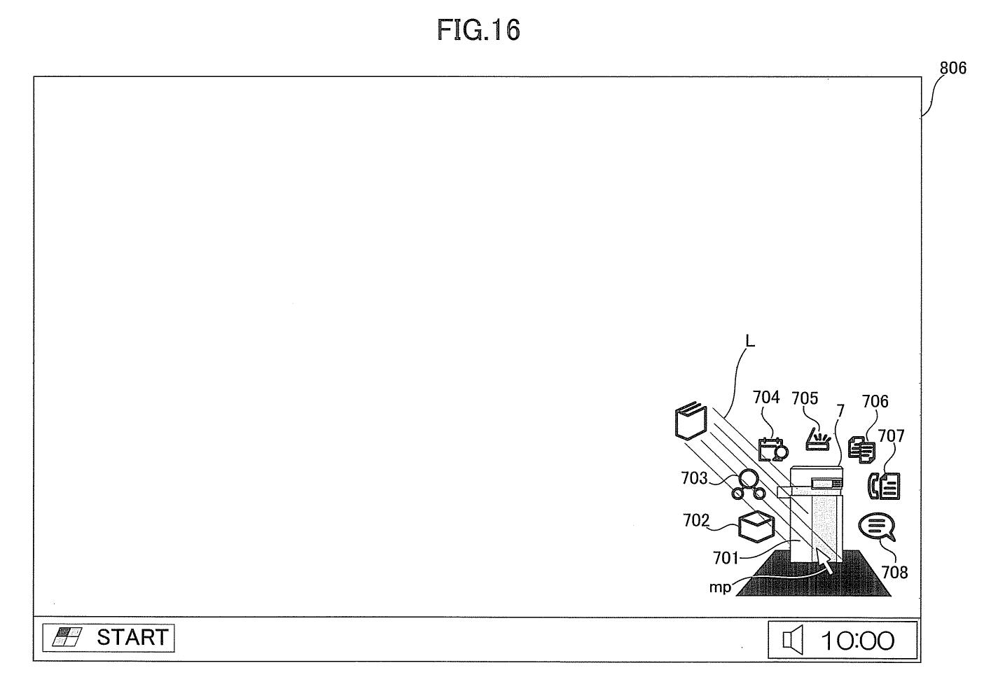

FIG. 16 is a screen display example immediately after the user double-clicks the icon 701 with the mouse pointer mp.

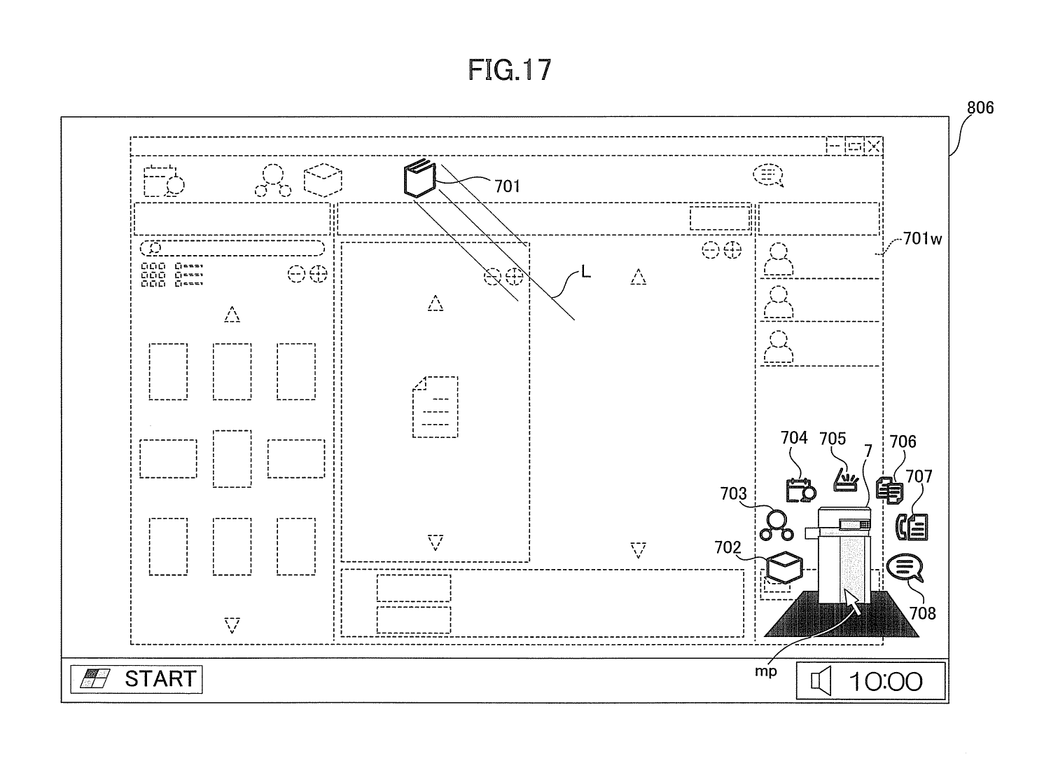

FIG. 17 is a diagram of a positional relation between the position of the icon 701 that reaches the title area T and a window 701w to be started by the double-click of the icon 701.

The setting-screen starting unit 203 starts the setting screen of the processing function corresponding to the “selected icon”, the selection of which is detected by the selection detecting unit 201 (ACT 203).

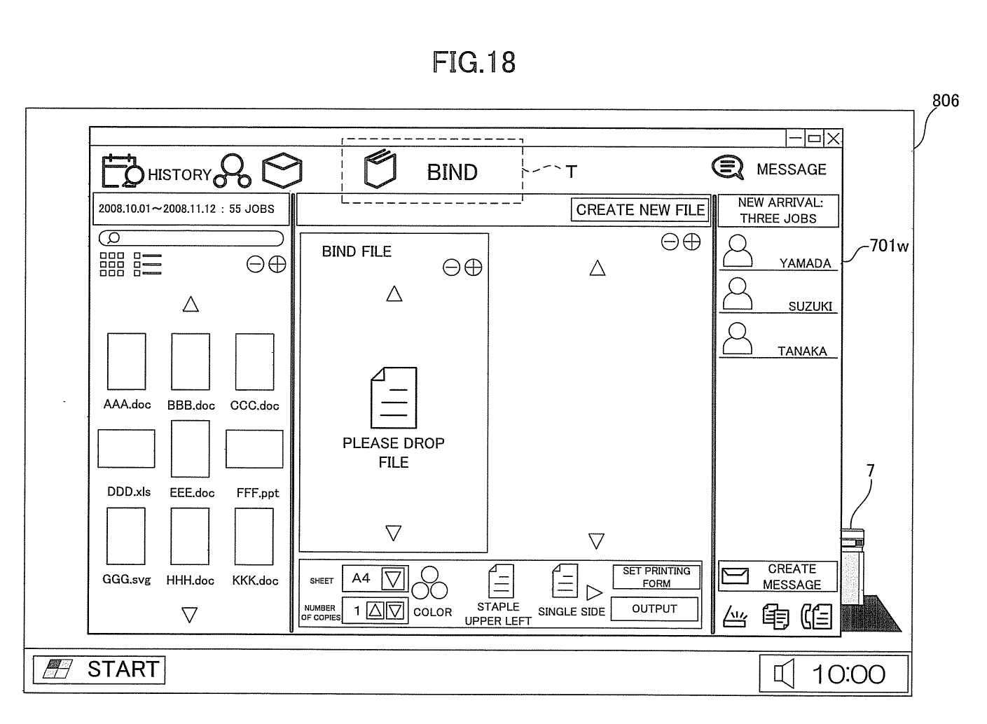

FIG. 18 is a display example of the window 701w started by the setting-screen starting unit 203 on the basis of the double-click of the icon 701. When the window 701w is displayed, the window 701w is displayed more in the front than the icon 7.

In general, in the title area T, a title indicating what the window is like (e.g., an application name, a service name, or a file name) is often displayed. Therefore, since the double-clicked icon finally moves to the title area while showing the locus to the title area, it is possible to naturally lead the line of sight of the user from the icon to the window. The user can easily grasp what kind of setting screen the icon selected by the user relates to.

A computer program for causing a computer included in the device managing apparatus to execute the operations explained above can be provided as a device managing program. In the example explained in this embodiment, the computer program for realizing a function for carrying out the present invention is recorded in advance in a storage area provided in the apparatus. However, the present invention is not limited to this. The same computer program may be downloaded from the network to the apparatus. The same computer program stored in a computer-readable recording medium may be installed in the apparatus. A form of the recording medium may be any form as long as the recording medium can store the computer program and is computer-readable. Specifically, examples of the recording medium include internal storage devices implemented in the inside of the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. A function obtained by installation or download in advance in this way may be realized in cooperation with an OS (operating system) in the apparatus.

The computer program may be an execution module that is dynamically generated partially or entirely.

It goes without saying that it is possible to cause the ASIC 802 to execute, in terms of a circuit, at least a part of various kinds of processing realized by causing a processor to execute the computer program in the embodiments explained above.

As explained above in detail, according to the technique described in this specification, it is possible to provide a technique for managing processing functions of a control target device.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A device managing apparatus comprising:
a display unit configured to display plural icons for starting setting screens respectively corresponding to plural kinds of processing functions of a target device set as a control target;
a state-information acquiring unit configured to acquire state information concerning processing states of the respective plural kinds of processing functions in the target device;
a waiting-time-information predicting unit configured to predict waiting time information concerning waiting times required, when the respective processing functions are instructed to perform new jobs, until start of execution of the new jobs on the basis of the state information acquired by the state-information acquiring unit; and
a waiting-time reflecting unit configured to reflect the waiting time information predicted by the waiting-time-information predicting unit on display states of the icons respectively corresponding to the plural processing functions.

2. The apparatus according to claim 1, wherein the waiting-time reflecting unit causes the display unit to display an icon corresponding to a processing function having longer waiting time indicated by the waiting time information predicted by the waiting-time-information predicting unit to be more highlighted than the other icons.

3. The apparatus according to claim 2, wherein the waiting-time reflecting unit causes the display unit to execute, for the icon corresponding to the processing function having the longer processing time indicated by the waiting time information, at least any one of a reduction in a time interval of blinking, an increase in size of the icon, an increase in chroma, an increase in brightness, an increase in line thickness, and an increase in size of a font.

4. The apparatus according to claim 1, wherein the state-information acquiring unit acquires presence or absence of function execution, setting content of a job being executed, a processing amount of the job being executed, setting content of a job scheduled to be executed, and presence or absence of setting operation in the respective plural kinds of processing functions.

5. The apparatus according to claim 1, wherein
the target device includes an imaging unit configured to pickup an image of a user present near the target device,
the state-information acquiring unit acquires image data obtained by picking up an image of the user with the imaging unit, and
the waiting-time reflecting unit causes the display unit to display an image based on the image data acquired by the state-information acquiring unit.

6. The apparatus according to claim 5, further comprising an authentication processing unit configured to perform authentication processing for the user on the basis of the image data acquired by the state-information acquiring unit.

7. The apparatus according to claim 1, further comprising a setting-function determining unit configured to determine for which of the plural kinds of processing functions the user is executing setting operation, wherein
the waiting-time reflecting unit performs reflection on a display state of the waiting time information concerning only an icon corresponding to a processing function that affects waiting time until execution of a processing function for which setting operation is determined by the setting-function determining unit as being executed.

8. The apparatus according to claim 1, wherein the icon display unit annularly arrays, around an icon corresponding to the target device, the plural icons and causes the display unit to display the icons.

9. A device managing method comprising:
causing a display unit to display plural icons for starting setting screens respectively corresponding to plural kinds of processing functions of a target device set as a control target;
acquiring state information concerning processing states of the respective plural kinds of processing functions in the target device;
predicting waiting time information concerning waiting times required, when the respective processing functions are instructed to perform new jobs, until start of execution of the new jobs on the basis of the acquired state information; and
reflecting the predicted waiting time information on display states of the icons respectively corresponding to the plural processing functions.

10. The method according to claim 9, further comprising causing the display unit to display an icon corresponding to a processing function having longer waiting time indicated by the predicted waiting time information to be more highlighted than the other icons.

11. The method according to claim 10, further comprising causing the display unit to execute, for the icon corresponding to the processing function having the longer waiting time indicated by the waiting time information, at least any one of a reduction in a time interval of blinking, an increase in size of the icon, an increase in chroma, an increase in brightness, an increase in line thickness, and an increase in size of a font.

12. The method according to claim 9, wherein the state-information acquiring unit acquires presence or absence of function execution, setting content of a job being executed, a processing amount of the job being executed, setting content of a job scheduled to be executed, and presence or absence of setting operation in the respective plural kinds of processing functions as the state information.

13. The method according to claim 9, wherein
the target device includes an imaging unit configured to pickup an image of a user present near the target device, and
the method further comprises:
acquiring image data obtained by picking up an image of the user with the imaging unit; and
causing the display unit to display an image based on the acquired image data.

14. The method according to claim 13, further comprising performing authentication processing for the user on the basis of the acquired image data.

15. The method according to claim 9, further comprising:
determining for which of the plural kinds of processing functions the user is executing setting operation; and
performing reflection on a display state of the waiting time information concerning only an icon corresponding to a processing function that affects waiting time until execution of a processing function for which setting operation is determined as being executed.

16. A device managing apparatus comprising:
a selection detecting unit configured to detect selection of an icon for starting a setting screen corresponding to a processing function of a target device set as a control target;
a display unit configured to display, when the selection of the icon is detected by the selection detecting unit, while showing a moving locus, the selected icon, the selection of which is detected by the selection detecting unit, to move from a position at time of the selection of the selected icon to a position of a title area where a title of a setting screen of a processing function corresponding to the selected icon is shown; and
a setting-screen starting unit configured to start the setting screen of the processing function corresponding to the selected icon.

17. The apparatus according to claim 16, wherein
the setting screen started by the setting-screen starting unit includes plural windows, and
the display unit displays, while showing a moving locus, the selected icon to move to a position of a title area where a title of a window having a predetermined relation with the processing function among the plural windows corresponding to the processing function is shown.

18. The apparatus according to claim 16, wherein the display unit displays, while keeping a display form at time of the selection of the selected icon and showing a moving locus, the selected icon to move from the position at the time of the selection of the selected icon to the position of the title area where the title of the setting screen of the processing function corresponding to the selected icon is shown.

19. The apparatus according to claim 16, wherein the display unit changes, according to a type of the selected icon, a display state of the selected icon moving from the position at the time of the selection of the selected icon to the position of the title area where the title of the setting screen of the processing function corresponding to the selected icon is shown.

20. The apparatus according to claim 19, wherein the display unit changes, according to a type of the selected icon, at least any one of a time interval of blinking, a shape, a color, brightness, thickness of a line, and size of a font of the selected icon.

21. An icon display controlling method comprising:
detecting selection of an icon for starting a setting screen corresponding to a processing function of a target device set as a control target;
causing, when the selection of the icon is detected, a display unit to display, while showing a moving locus, the selected icon, the selection of which is detected, to move from a position at time of the selection of the selected icon to a position of a title area where a title of a setting screen of a processing function corresponding to the selected icon is shown; and
starting the setting screen of the processing function corresponding to the selected icon.

22. The method according to claim 21, wherein
the setting screen to be started includes plural windows, and
the method further comprising causing the display unit to display, while showing a moving locus, the selected icon to move to a position of a title area where a title of a window having a predetermined relation with the processing function among the plural windows corresponding to the processing function is shown.

23. The method according to claim 21, further comprising causing the display unit to display, while keeping a display form at time of the selection of the selected icon and showing a moving locus, the selected icon to move from the position at the time of the selection of the selected icon to the position of the title area where the title of the setting screen of the processing function corresponding to the selected icon is shown.

24. The method according to claim 21, further comprising changing, according to a type of the selected icon, a display state of the selected icon moving from the position at the time of the selection of the selected icon to the position of the title area where the title of the setting screen of the processing function corresponding to the selected icon is shown.

25. The method according to claim 24, further comprising changing, according to a type of the selected icon, at least any one of a time interval of blinking, a shape, a color, brightness, thickness of a line, and size of a font of the selected icon.
